(19) United States
(12) Patent Application Publication
(10) Pub. No.: US 2022/0083266 A1
(43) Pub. Date: Mar. 17, 2022

(54) PLANE-BASED QUEUE CONFIGURATION FOR AIPR-ENABLED DRIVES

(71) Applicant: Kioxia Corporation, Minato City (JP)

(72) Inventors: Gyan Prakash, San Jose, CA (US); Vijay Sankar, San Jose, CA (US); Suresh Karpurapu, Bangalore (IN); Amit Kumar, Bangalore (IN)

(21) Appl. No.: 17/022,911

(22) Filed: Sep. 16, 2020

(51) Int. Cl. G06F 3/06

(52) U.S. Cl. CPC G06F 3/0659; G06F 3/0604; G06F 3/0679

(57) ABSTRACT

A processor coupled to an AIPR-enabled NAND memory device comprising an n by m array of dies having n channels, each die having first and second independently accessible planes, receives read commands including instructions to access data on planes of a die. The processor determines the destination die plane of the command and sends the command to a die plane queue based on the determined destination die plane. The processor fetches commands from a head of a first die plane queue for a first plane of the destination die and a head of a second die plane queue for the second plane of the destination die, and performs reads at both the first and second planes of the destination die in parallel based on the commands.

### FIELD OF THE INVENTION

The present invention generally relates to systems and methods to schedule messages on a processor of an asynchronous independent plane read (“AIPR”) enabled memory device.

### BACKGROUND OF THE INVENTION

In a memory system, such as a solid state drive (“SSD”), an array of memory devices is connected to a memory controller via a plurality of memory channels. A processor in the memory controller maintains a queue of memory commands for each channel and schedules commands for transmission to a memory device.

Data is written to one or more pages in a memory device. Multiple pages form a block within the device, and blocks are organized into two physical planes. Typically, one plane includes odd numbered blocks and the other includes even numbered blocks. Data written to the device can be accessed and read out of the device by a memory controller of the SSD.

Conventional memory controller processors schedule memory commands in the queues according to a round-robin selection method, scheduling the command at the head of the selected queue for transmission to a memory device. Memory controller processors schedule a variety of types of memory commands and messages, from a variety of sources. Conventionally, controllers schedule a particular type of read command to the die one at a time, failing to take into account the location of the read command within the dies.

When a read memory command fails to read data correctly, the processor attempts error correction. If this fails, conventionally the processor creates one or more new commands, placed in a single error recovery queue to attempt recovery of the data. A response to the original read command must wait until data recovery completes, which increases the latency of read commands which encounter failures. When many read errors occur in a short time period, a large number of error recovery commands will be added into a single queue to be handled in serial fashion, further increasing the latency of the read commands.

The conventional grouping of commands into a single queue does not account for the different types and priorities of read commands issued to the memory controller processor, including both host originated read commands and internal read commands created by the memory controller. For example, a host issued read command with strict latency requirements may be positioned after an internal read error recovery commands in the queue awaiting scheduling. These issues become more prominent and problematic as the wear on the memory device increases with age and the number of reported errors increases.

Accordingly, there is a long felt and unmet need for memory controllers to be capable of efficiently scheduling commands to memory devices.

### BRIEF DESCRIPTION OF THE INVENTION

In an aspect, a processor capable of scheduling read commands is communicatively coupled to a NAND memory device having an n×m array of NAND memory dies having n channels, where each channel of the n channels is communicatively coupled to m NAND memory dies, and each of the n×m NAND memory dies has a first plane and a second plane and the first and second planes are independently accessible. A method for scheduling read commands using the processor includes receiving a first command to perform a first read on a destination die of the n×m array of NAND memory dies, determining the destination die and a first destination plane of the first read command, and sending the first read command to a first die plane queue associated with the destination die and first destination plane.

In another aspect, a system for scheduling read commands at a processor includes a NAND memory device having an n×m array of NAND memory dies having n channels, where each channel of the n channels is communicatively coupled to m NAND memory dies, and each of the n×m NAND memory dies has a first plane and a second plane and the first and second planes are independently accessible. The system also includes a processor communicatively coupled to the NAND memory device, the processor having logic configured to process read commands requesting data from the NAND memory device, and a die queue for each of a first plane and a second plane of each NAND memory die of the n×m array. The processor receives a first command to perform a first read on a destination die of the n×m array of NAND memory dies, determines the destination die and a first destination plane of the first read command, and sends the first read command to a first die plane queue associated with the destination die and first destination plane.

### BRIEF DESCRIPTION OF THE FIGURES

The foregoing and other objects and advantages will be apparent upon consideration of the following detailed description, taken in conjunction with the accompanying drawings, in which like reference characters refer to like parts throughout, and in which:

FIG. 1 shows a block diagram of a solid-state drive (“SSD”) memory device system which supports scheduling of error recovery messages and read commands;

FIG. 2 shows a block diagram of a process of read commands and read errors in an SSD memory device;

FIG. 3A shows a block diagram of a process of message scheduling without die plane read command queues;

FIG. 3B shows a block diagram of a process of message scheduling with die plane read command queues;

FIG. 4A shows a block diagram of a process of message scheduling with die-based queues;

FIG. 4B shows a block diagram of a process of message scheduling with die plane queues;

FIG. 5 shows a block diagram of a mapping of read commands to a die- and plane-based queue for a 4-channel by 4-bank configuration;

FIG. 6 shows a flow chart of a method for error recovery of read commands with die plane error recovery queues; and

FIG. 7 shows a flow chart of a method for scheduling error recovery messages to multiple planes of a die.

### DETAILED DESCRIPTION OF THE INVENTION

To provide an overall understanding of the devices described herein, certain illustrative embodiments will be described. Although the embodiments and features described herein are specifically described for use in connection with a SSD having a controller, it will be understood that all the components and other features outlined below may be combined with one another in any suitable manner and may be adapted and applied to other types of SSD architectures requiring scheduling of various commands on die arrays.

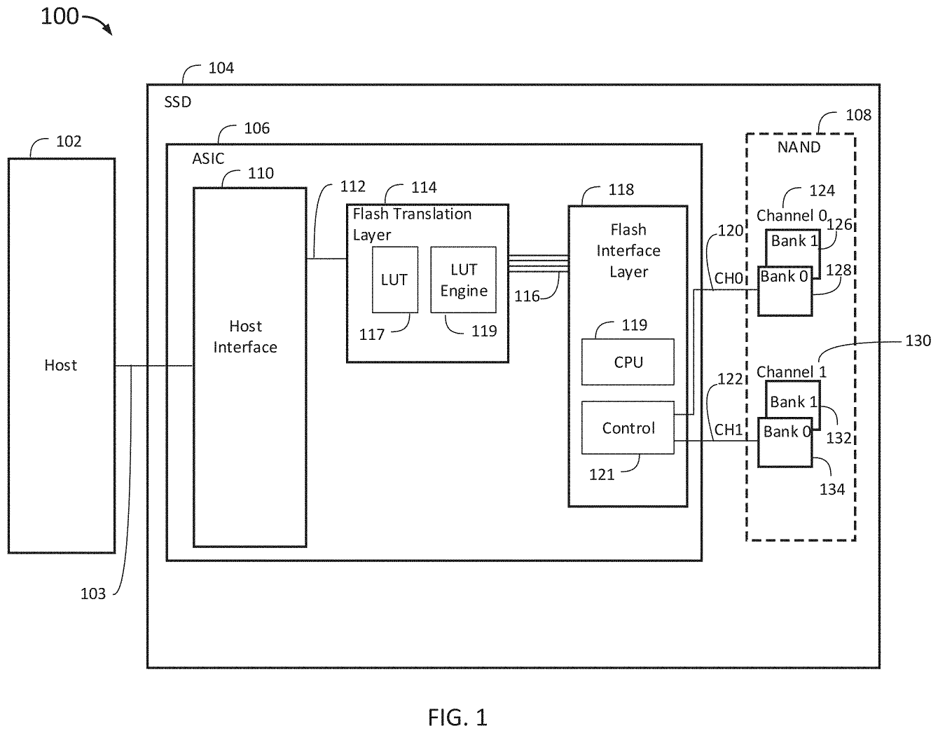

FIG. 1 shows a block diagram of an SSD memory device system 100. The SSD memory device system 100 includes an SSD 104 communicatively coupled to a host 102 by bus 103. The SSD 104 includes an application-specific integrated circuit (“ASIC”) 106 and NAND memory device 108. The ASIC 106 includes a host interface 110, a flash translation layer 114, and a flash interface layer 118. The host interface 110 is communicatively coupled to the flash translation layer 114 by internal bus 112. The flash translation layer 114 includes a lookup table (“LUT”) 117 and LUT engine 119. The flash translation layer 114 transmits memory commands 116 to the flash interface layer 118. The flash interface layer 118 includes a flash interface central processing unit (“CPU”) 119 and a flash interface controller 121. The flash interface CPU 119 controls the flash interface controller 121. The flash interface layer 118 is communicatively coupled to the flash interface controller 121 which is communicatively coupled to the NAND memory device 108 by multiple NAND memory channels. Two channels are illustrated here for clarity, but any number of channels may couple the flash interface controller 121 to memory within the NAND memory device 108. As illustrated, flash interface controller 121 is coupled by first channel (Ch 0) 120 to multiple banks 124 of memory die, here including first bank 126 and second bank 128. Flash interface controller 121 is coupled by second channel (Ch 1) 122 to multiple banks 130 of memory die, here including third bank 132 and fourth bank 134. While only two banks are shown in FIG. 1 for each of the channels, any number of banks can be coupled to the channels.

Each bank of the first bank 126, second bank 128, third bank 132, and fourth bank 134, has a first plane and a second plane (not shown for clarity). The planes are typically referred to as even (P0) and odd (P1). An AIPR-enabled SSD 104 allows independent access to the planes of each bank, such that the first and second planes can be accessed in parallel at the same time. Individual clusters in either of the planes can be accessed independently during execution of a read command on the banks.

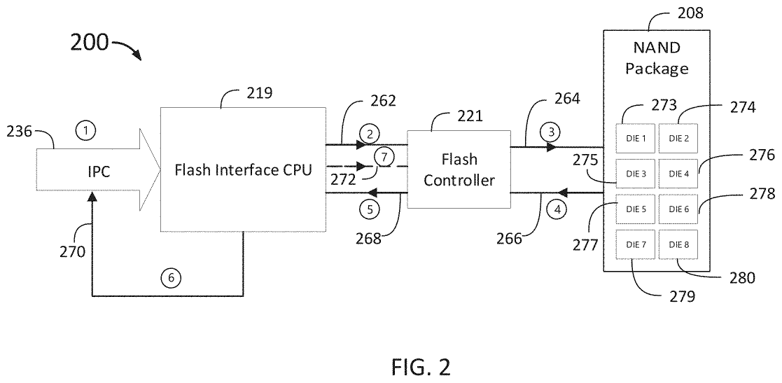

The SSD 104 receives various storage protocol commands from the host 102 to access data stored in the NAND memory device 108. The commands are first interpreted by the flash translation layer 114 into one or more memory commands 116 which are routed to the flash interface layer 118 in multiple queues, for example multiple inter-process communication (“IPC”) queues. The SSD 104 may also generate internal commands and messages that require accessing data stored in the NAND memory device 108, which are also routed to the flash interface layer 118 IPC queues. The flash interface layer 118 assigns the commands and messages to the appropriate IPC queue before fetching commands in order from the queues to be scheduled and processed by the flash interface CPU 119. The flash interface CPU 119 sends instructions to the flash controller 121 to perform various tasks based on the scheduled commands and messages. This process of distributing commands and messages to IPC queues and the flash interface CPU 119 fetching and processing the commands and messages is further described in FIG. 2. Though IPC queues are described herein, the various commands and messages routed to the flash interface layer may be assigned to any appropriate queue, and the queue need not be an IPC queue.

As used herein, a person of skill would understand the term ‘message’ to mean a means to convey an instruction, directive containing information. The term ‘error recovery message’ would be understood by a person of skill to mean an instruction or directive containing information as to what happened in an error on a memory die and how the error can be recovered from. An error recovery message, as used herein, may also be understood as a communication, report, task, order, or request to perform error recovery, such that in response to the content of an error recovery message the CPU forms a command to perform an error recovery action on a memory die. As an example, an error recovery message may result in a set of read commands being issued to the memory die which define different voltage thresholds for the read commands. Though IPC queues are described herein, the various commands and messages routed to the flash interface layer may be assigned to any appropriate queue, and the queue need not be an IPC queue.

FIG. 2 shows a block diagram 200 of a process of handling read commands and read error recovery messages (also referred to herein as read error recovery instructions) in an SSD memory device, such as SSD 104 in FIG. 1. The block diagram 200 shows the flow of the processing method starting from the commands and messages in the IPC queues 236, to the flash interface CPU 219, to the flash controller 221, and to the NAND memory device 208. The flash interface CPU 219 and the flash controller 221 are components within the flash interface (for example flash interface layer 118 of FIG. 1). At step 1, the flash interface CPU 219 fetches a read command as an IPC message from a head of a queue in IPC queues 236. The flash interface CPU 219 fetches the commands from the heads of the IPC queues 236 according to a scheduling algorithm. In some implementations, the scheduling algorithm is a round-robin strategy, which gives equal priority weighting to each queue. In some implementations, another scheduling algorithm is used. In some implementations, the scheduling algorithm enables the flash interface CPU 219 to fetch multiple IPC messages from the head of the queue based on the attributes of read messages fetched. In some implementations, the scheduling algorithm enables the flash interface CPU 219 to fetch a command from a position in a queue other than the head of a queue. In some implementations, the scheduling algorithm accounts for varying priority of queues within the IPC queues 236. The flash interface CPU 219 processes the commands and transmits instructions to the flash controller 221 to issue memory command signals on the memory channel to the NAND memory device 208 in response to the commands and messages.

At step 2, the flash interface CPU 219 creates a read packet based on the received IPC message and transmits 262 the read packet to the flash controller 221. The flash controller 221 processes the read packet and transmits the read command signals to the NAND memory device 208 at step 3 over pathway 264. The flash controller 221 transmits the command signals to the NAND memory device 208 over the appropriate channel (for example first channel (Ch0) 120 or second channel (Ch 1) in FIG. 1) to reach the destination bank (for example first bank 126, second bank 128, third bank 132, or fourth bank 134 in FIG. 1) for execution of the read. The read command may request clusters of data from one of the planes of the destination bank. The flash controller 221 transmits the command signals to the correct bank and plane of the NAND memory device 208 to access the data specified by the read command. As will be discussed below, in some implementations, when the NAND memory device 208 belongs to an AIPR-enabled SSD, the flash controller 221 is able to transmit command signals to multiple planes of a single bank in order to independently access data from the planes in parallel. The NAND memory device 208 is shown in FIG. 2 with eight available dies including first die 273, second die 274, third die 275, fourth die 276, fifth die 277, sixth die 278, seventh die 279, and eighth die 280. Each die includes an even plane (P0) and an odd plane (P1) which are independent from one another.

In many cases, the read command will be successfully executed, but if an error occurs, the flash controller 221 attempts error recovery. For example, at step 4, an indication responsive to the attempted execution of the read at the NAND memory device 208 along with any data read is detected by the flash controller 221 at pathway 266. The indication may indicate a failure of the execution of the memory read command and no data is returned, or the indication indicates success and data is returned. The flash controller 221 checks the data returned using an error correcting code (“ECC”) decoder (not shown for clarity) which may indicate either success (that the data has been read successfully) or failure (that an uncorrectable ECC failure has occurred). The flash controller 221 transmits the indication of a memory read failure or an ECC failure to the flash interface CPU 219 at step 5 by pathway 268. In response to the indication of the read error as a result of the memory read failure or ECC failure, the flash interface CPU 219 must attempt to recover the data using one of various read error recovery methods. In some implementations, the flash interface CPU 219 executes an enhanced, stronger error correction algorithm to attempt correction of identified errors. In some implementations, the flash interface CPU 219 determines new memory cell threshold voltage values based on an error recovery algorithm to attempt recovery of the identified errors. In some implementations, the flash interface CPU 219 prepares one or more read commands having various threshold voltage values to re-attempt the memory read on the NAND memory device 208. Each of these error recovery algorithms, as well as known alternative error recovery algorithms and methods, may be used in combination with one or more of the embodiments described herein.

At step 6, the flash interface CPU 219 prepares a new error recovery IPC message including relevant details about the read to perform the necessary recovery steps, and transmits the IPC message to its own IPC queue to issue further read correction steps. When more than one read error occurs at a time, more error recovery IPC messages are created by the flash interface CPU 219 and added to the IPC queue. In order to efficiently handle these error recovery messages, the messages must be appropriately grouped. Messages and commands may be grouped according to the type of command or message, for example into a response message queue group, an error recovery queue group, a host read commands queue group, and another command queue group encompassing read, write, and erase commands other than host-initiated commands, or any other appropriate groupings. The priority of commands and messages can also be accounted for in the grouping of commands and messages. Accordingly, in step 6, when the flash interface CPU 219 transmits the message to its own IPC queue, the message must be assigned to an appropriate queue within the IPC queues 236. In some implementations, the flash interface CPU 219 transmits the error recovery IPC message to a die-based queue within the IPC queues 236, and further may specify the destination plane in the die and transmit the error recovery IPC message to a die plane queue. The IPC queues 236 includes at least one error recovery IPC queue per die within the NAND memory device 208, and, as will be described in greater detail below, may include multiple queues for each die to account for the destination plane or a priority of the error recovery instruction.

The error recovery IPC message is an indication that an error has occurred, and may also include indications as to the type and severity of the error, which dictate how the message is processed when it reaches the head of its respective IPC queue. Once the error recovery message reaches the front of an IPC queue and is fetched for scheduling, the flash interface CPU 219 processes the error recovery message to determine the actions required by the message. At step 7, the flash interface CPU 219 issues a read packet based on the error IPC message by pathway 272 to the flash controller 221 for transmission to the NAND memory device 208. As described above, in some implementations, the read packet includes updated threshold voltage values to attempt to recover the data. In some implementations, the read packet addresses the data recovery by another read error correction or recovery method. The steps 1-7 are repeated until the read error is fully corrected.

The scheduling of read commands to memory devices that are AIPR-enabled is improved by scheduling commands to access the planes of a die in parallel. Scheduling read commands to both planes in parallel reduces random read command latency because commands to access the planes can be equally scheduled rather than scheduled merely to a die where one plane may not be accessed at all while multiple read commands wait to execute on the other plane. Scheduling of other commands and messages to AIPR-enabled memory devices can also be improved by scheduling to the multiple planes in parallel, for example error recovery messages can be scheduled to the first and second planes of a die in parallel using die plane queues. Errors in the dies of the NAND memory device 208 that prevent the completion of a command occur randomly, and are likely to increase with increased age and wear of a die. In conventional systems, all error recovery messages are routed to a single error recovery message IPC queue creating a long wait for scheduling of the messages and ineffective use of resources. Use of a single error recovery message IPC queue results in large latency times and fails to take into account that various commands, and error recovery messages responsive to them, may have different priority levels and associated levels of acceptable latency. Further, failure to account for the destination plane on the die increases latency in AIPR-enabled drives during both read command processing and read error recovery command processing.

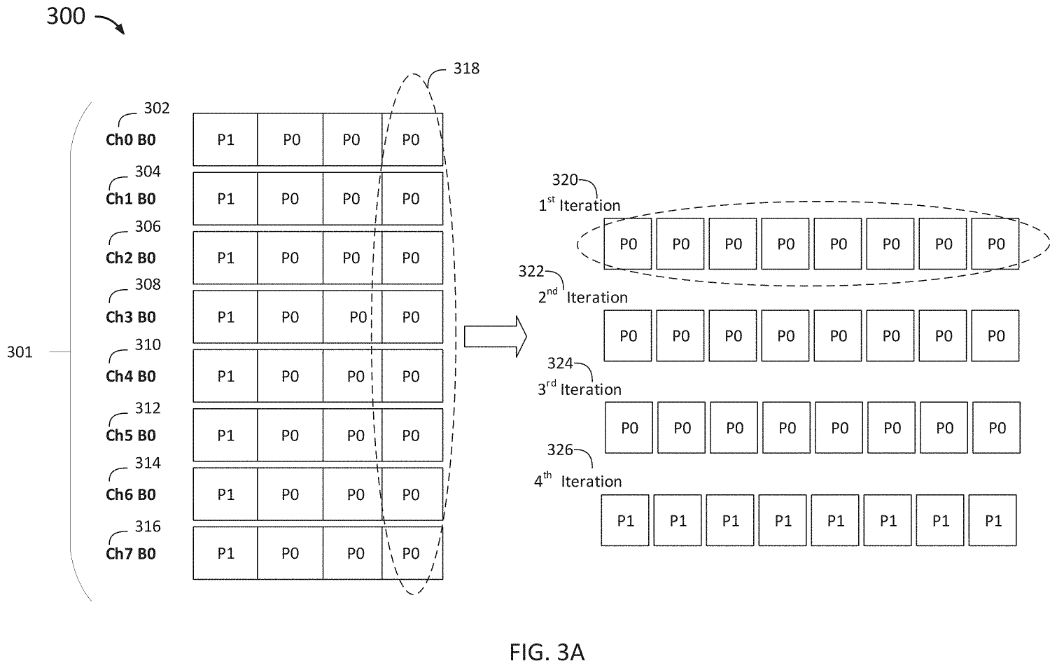

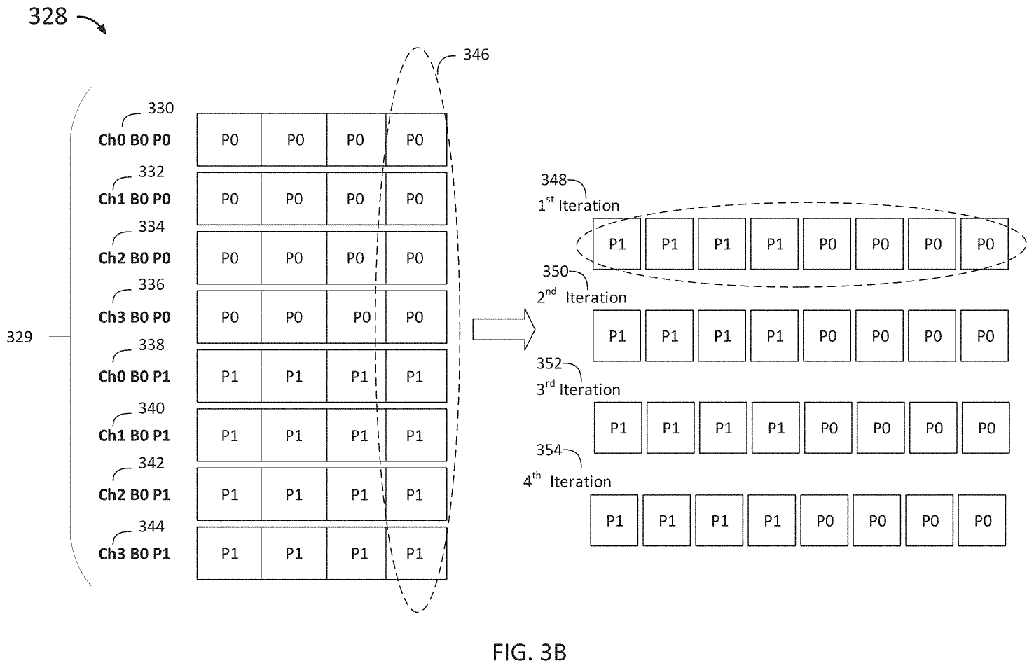

FIG. 3A shows a block diagram 300 of a process of message scheduling without die plane read command queues. FIG. 3A illustrates the conventional method of scheduling read commands sent to the CPU (for example flash interface CPU 119 in FIG. 1 or flash interface CPU 219 in FIG. 2) from the IPC queues 301. IPC queues 301 includes first die read command queue 302, second die read command queue 304, third die read command queue 306, fourth die read command queue 308, fifth die read command queue 310, sixth die read command queue 312, seventh die read command queue 314, and eighth die read command queue 316. Each die read command queue in the IPC queues 301 is associated with a particular channel and a particular bank or die accessed by the channel. For example, the first die read command queue 302 contains read commands destined for channel 0 and bank 0, while second die read command queue 304 contains read commands destined for channel 1 and bank 0, and so on.

Each queue in the IPC queues 301 contains multiple commands or messages instructing the CPU to perform reads of particular destinations on the channels and banks of the memory device. For each scheduling iteration, the CPU selects a command for scheduling from the head of each die-based read command queue of the IPC queues 301. The CPU then performs a second iteration, selecting the next head command in each of the queues.

The read commands in FIG. 3A are arranged in the IPC queues 301 according to the destination die as indicated by the channel and die targeted by the read command, but without consideration of the destination plane of the command. Accordingly, within each queue the read commands are randomly ordered such that there may be many read commands that require accessing a first plane of a die in the queue ahead of a command requiring access of the second plane of the die. This is the case in the IPC queues 301 of FIG. 3A, in which each queue of the IPC queues 301 contains three read commands that require access of the first plane P0 of the destination die, and then a fourth read command requiring access of the second plane P1.

Accordingly, in the first iteration 320, for example, the CPU selects the read commands indicated by selection 318, all requiring access of the first plane P0 of the destination dies. In the second scheduling iteration 322, the CPU selects the next read commands now at the heads of the IPC queues 301, and the selection also includes only read commands requiring access of the first plane P0 of the destination dies. In the third scheduling iteration 324, the CPU selects the next read commands now at the heads of IPC queues 301, and again the selected commands only include read commands requiring access of the first plane P0 of the destination dies. Finally, in the fourth scheduling iteration, the CPU selects the next read commands now at the heads of the IPC queues 301 and now the selected commands only include read commands requiring access of the second plane P1 of the destination dies.

In conventional SSDs, such method is acceptable because only one plane of each die can be accessed at a time, so there is no inefficiency in combining read instructions for both planes of a die into a single queue. All planes are eventually read in the order of the commands in the IPC queues. However, in an AIPR-enabled SSD where the planes can be operated independently and accessed in parallel, scheduling according to this conventional method is inefficient. Using the example IPC queues 301 of FIG. 3A, the CPU must make four scheduling iterations before any read commands directed to a second plane P1 are selected for scheduling. During the execution of commands in the first three iterations the second planes of the dies will be idle, preventing the AIPR-enabled SSD from fully realizing maximum performance efficiency. At any time during the execution of commands for the first plane P0, commands for the second plane P1 could be issued in parallel to the commands for the first plane P0.

FIG. 3B shows a block diagram 328 of a process of message scheduling with die plane read command queues. FIG. 3B illustrates a method of scheduling read commands sent to the CPU (for example flash interface CPU 119 in FIG. 1 or flash interface CPU 219 in FIG. 2) using die plane IPC queues 329. IPC queues 329 includes first die plane read command queue 330, second die plane read command queue 332, third die plane read command queue 334, fourth die plane read command queue 336, fifth die plane read command queue 338, sixth die plane read command queue 340, seventh die plane read command queue 342, and eighth die plane read command queue 344. Each die plane read command queue in the IPC queues 329 is associated with a particular channel and a particular bank or die accessed by the channel as well as a particular plane of the die. For example, the first die plane read command queue 330 contains read commands destined for the first plane P0 of the die at channel 0 and bank 0, while fifth die plane read command queue 338 contains read commands destined for the second plane P1 of the die at channel 0 and bank 0.

Each queue in the die and plane based IPC queues 329 contains multiple commands or messages instructing the CPU to perform reads of particular die plane destinations on the channels and banks of the memory device. For each scheduling iteration, the CPU selects a command for scheduling from the head of each die-based read command queue of the IPC queues 329. The CPU then performs a second iteration, selecting the next head command in each of the queues.

Unlike the die-based queues of FIG. 3A, the read commands in FIG. 3B are arranged in the IPC queues 329 according to the destination die and destination plane of the die targeted by the read command. Accordingly, each die plane queue includes read commands only for a particular die and plane. For example, in the IPC queues 329 of FIG. 3B, first die plane read command queue 330 includes only commands for execution on the first plane P0 of the first die (BO) on the first channel (Ch0), while fifth die plane read command queue 338 includes only commands for execution on the second plane P1 of the first die (BO) on the first channel (Ch0). In each scheduling iteration, the CPU will select one command from each of the first die plane read command queue 330 and the fifth die plane read command queue 338, and the two commands can be executed in parallel on the first plane P0 and second plane P1 of the first die (BO) on the first channel (Ch0), respectively.

In the first scheduling iteration 346, for example, the CPU selects the read commands indicated by selection 348, including commands directed to the first planes (P0) and second planes (P1) of each of the dies. Likewise, in each of the second scheduling iteration 350, third scheduling iteration 352, and fourth scheduling iteration 354, the CPU selects the next read commands now at the heads of the die plane IPC queues 329 including read commands for execution at both the first and second planes of each die. By separating the die-based command queues into separate queues for the first and second planes of each die, both planes are fully utilized in AIPR mode. Reads of the first plane (P0) and the second plane (P1) of the same die are selected by the CPU for execution in each scheduling iteration and can be carried out in parallel for increased efficiency relative to the conventional die-based queues of FIG. 3A. While FIGS. 3A and 3B illustrate the scheduling of read commands, the die plane queues illustrated in FIG. 3B can be used for scheduling of other types of commands and messages, such as read error recovery messages, in order to improve scheduling efficiency and optimize performance of the SSD.

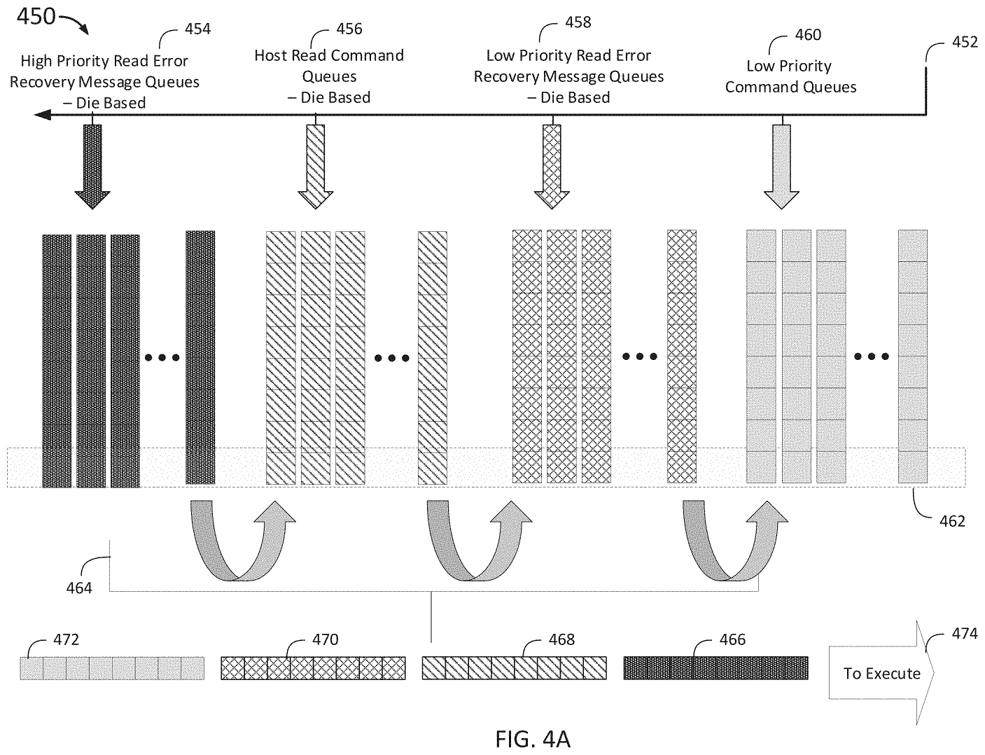

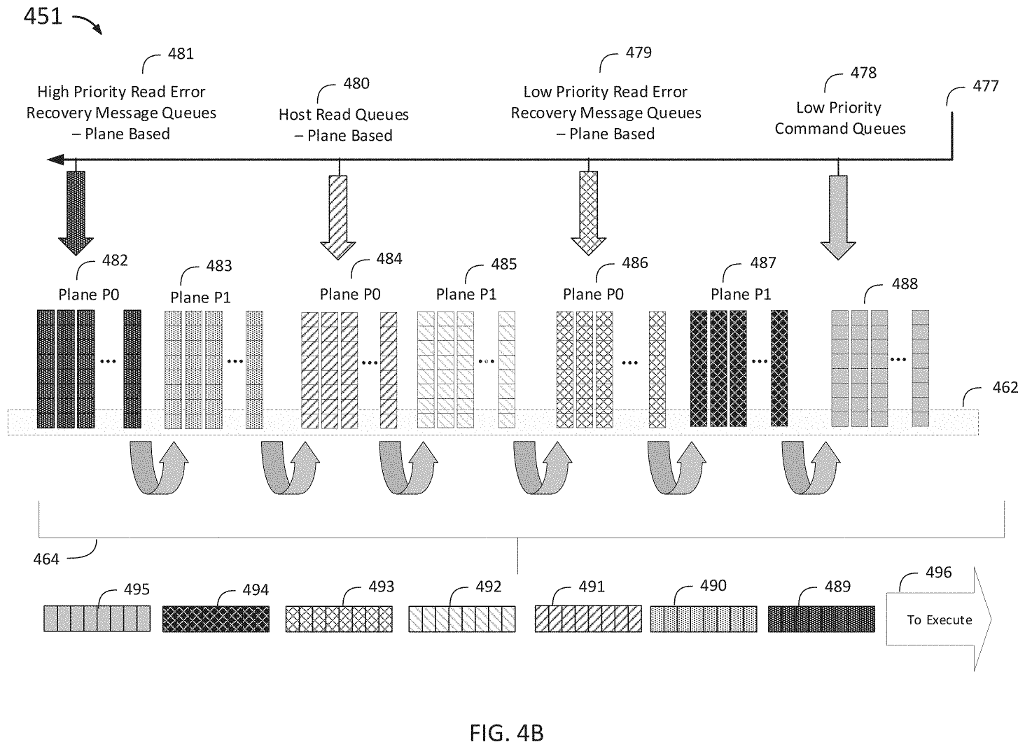

As an example of the utility of die plane based queues as described in FIG. 3B, FIGS. 4A and 4B illustrate the benefit of utilizing die plane IPC queues for efficient scheduling of read error recovery messages and read commands. FIG. 4A shows a method of transmitting read error recovery messages and read commands to die-based IPC queue specific to the destination die of the command. FIG. 4B further illustrates the additional efficiency of utilizing die plane queues for AIPR-enabled SSDs that can independently access both die planes in parallel for performing a read or read error recovery. FIGS. 4A and 4B illustrate scheduling of error recovery messages, host read commands, and other low priority commands for processing. The same process of transmitting messages and commands to die plane queues as illustrated in FIG. 4B can be applied to the scheduling of error recovery messages and read commands as illustrated, as well as to other message and command types. For an AIPR-enabled SSD, the division of any die-based queue into a queue for die plane 0 and a queue for die plane 1, will increase the efficiency of scheduling messages and commands that can be independently executed at the die planes in parallel.

FIG. 4A shows a block diagram 450 of a process of IPC message scheduling at the flash interface CPU (for example flash interface CPU 119 in FIG. 1 or flash interface CPU 219 in FIG. 2) with multiple die-based command queues. In FIG. 4A as commands and messages are transmitted to the CPU, they are added to the tail of the appropriate IPC queue (step 452). The IPC queues include a plurality of high-priority die-based read error recovery message queues 454, die-based host read command queues 456, low priority read error recovery message queues 458, and low priority command queues 460. Read error recovery message queues are also referred to herein as read error recovery instruction queues and read error recovery message queues. These queues are shown for illustration, but more or other command queues may be also be designated at the flash interface for scheduling additional types of commands or instructions. When the CPU fetches the commands and messages from the heads of the queues according to a selection scheme (step 462), commands or messages are fetched from each of the heads of the queues in turn, including the high and low priority read error recovery message queues for each die. In some implementations, the selection process is a round-robin scheme. In some implementations, the CPU fetches a command from a position in the queue other than the head of the queue. In some implementations, the scheduling algorithm enables the CPU to fetch multiple IPC messages from the head of the queue based on the attributes of read messages fetched.

The CPU begins with the high priority read error recovery message queues 454 and fetches the message at the head of each die-based queue to form commands 466 for scheduling, before moving on (step 464) to fetch the commands at the head of each of the host read command queues 455 to form commands 468 for scheduling. The CPU then fetches the message at the head of each of the die-based queues of the low priority read error recovery message queues 458 to form commands 470 for scheduling, and then moves on (step 464) to finally fetch the command at the head of each queue in the low priority command queues 460 to form commands 472 for scheduling. The commands from the heads of the various queues including the plurality of die-based high priority read error recovery message queues 454, the plurality of host read command queues 456, the plurality of die-based low priority read error recovery message queues 458, and the plurality of low priority command queues 460 are all processed, and commands are formed and scheduled for transmission to the flash interface controller to execute the commands or take various actions (step 474). The CPU then begins a second iteration repeating the steps described above by fetching the command or message now at the head of each IPC queue and forming commands for scheduling.

Scheduling the messages from die-based high and low priority read error recovery message queues results in higher efficiency of scheduling and optimized handling of read errors leading to improved error recovery performance. The flash interface CPU is able to more flexibly schedule and process read error messages while also processing and scheduling other commands and messages. The use of die-based queues can generally improve performance and scheduling efficiency when applied to IPC queues that have been conventionally utilized as a single queue per channel, for example read error recovery instruction queues. For example, division of a read error recovery instruction queue into die-based queues can improve error handling for quad-level cell (“QLC”) devices, which may be more sensitive to error correcting code (“ECC”) errors. In some implementations, die-based error recovery queues can be easily scaled to accommodate various NAND architectures, such as IOD and IO Stream-based architectures, to improve error handling on these devices. This process is further described in U.S. patent application Ser. No. 17/022,848, titled “Die-based High and Low Priority Error Queues,” filed Sep. 16, 2020 and concerning the use of die-based high and low priority error queues for scheduling, which is incorporated by reference herein in its entirety.

In some implementations, the CPU can determine which priority queue each read error recovery message should be assigned based on the type of read command that failed. For example, if the failed read command was an internal read command, it can be assigned to the low priority queue, and if the failed read command was a host-initiated read command, then it can be assigned the high priority queue. The CPU fetches messages from each of the high and low priority queues for each of the die queues, so that the high priority error recovery messages need not wait in a queue behind a number of low priority messages. The messages can be processed and the read commands or other instructions for error recovery based on the message can be transmitted to the flash interface controller and transmitted to the NAND device in parallel to improve the efficiency of the error correction and data recovery.

In some implementations, each die-based error recovery message queue is separated into a high priority queue and a low priority queue, such that there are twice as many queues as there are dies in the NAND memory device. In some implementations, each die-based error recovery message queue is separated into multiple priority queues, for example into three, four, or more queues of varying priority. The division of each die-based queue into two or more priority queues may be used in combination with one or more of the aforementioned embodiments.

However, scheduling the commands and messages using die-based read error recovery message queues that do not account for the destination die plane of the message or command can result in inefficient scheduling to the die planes of an AIPR-enabled device that is capable of independently accessing the die planes in parallel, and may cause problems when higher priority messages become stuck in the queue behind less important messages to be executed on the die planes.

The high and low priority die-based read error recovery message queues can be further improved for use in AIPR-enabled devices by adding plane-based queues for each die-based read error recovery message queue. Because AIPR-enabled devices are capable of independently accessing both planes of a die simultaneously, the ability to schedule commands and messages to the specific planes can significantly increase efficiency and reduce latency. FIG. 4B shows a block diagram of a process of message scheduling with die plane high and low priority read error recovery message queues and die plane host read command queues. As described above with regard to FIG. 4A, in FIG. 4B as commands and messages are transmitted to the CPU, they are added to the tail of the appropriate IPC queue (step 477). The IPC queues include a plurality of die plane based high priority read error recovery message queues 481, a plurality of die plane based host read command queues 480, a plurality of die plane based low priority read error recovery message queues 479, and a plurality of low priority command queues 478. In contrast to the high and low priority read error recovery message IPC queues and host read queues of FIG. 4A, in FIG. 4B the high priority read error recovery message queues 481 are not just die-based with a queue assigned to each die, but are also plane based, such that there is a queue for each of the first plane P0 and second plane P1 of each die. Accordingly, the high priority read error recovery message queues 481 is separated into die plane queues associated with Plane P0 482 and die plane queues associated with Plane P1 483. Likewise, the low priority read error recovery message queues 479 is separated into die plane queues associated with Plane P0 486 and die plane queues associated with Plane P1 489. Host read command queues 480 is also further separated into die plane queues associated with Plane P0 484 and die plane queues associated with Plane P1 485. The low priority command queues 478 are neither die-based, nor separated by destination plane of the command. In some implementations, the low priority command queues or other command queues can also be separated into one or more of die-based queues, priority queues, and plane-based queues. When the CPU fetches the commands and messages from the heads of the queues according to a round-robin or other selection scheme (step 461), commands or messages are fetched from each of the heads of the queues in turn, including each of the die plane queues for the high and low priority read error recovery message queues and each of the die plane queues for the host read command queues, such that a command or message is fetched for each of the odd plane and the even plane of each die.

The CPU begins with the die plane based high priority read error recovery message queues 481 and fetches the message at the head of each queue in the die plane P0 high priority read error recovery message queues 482 to form commands 489 for scheduling, and fetches the message at the head of each queue in the die plane P1 high priority read error recovery message queue 483 to form commands 490 for scheduling. The CPU then moves on (step 464) to fetch the commands from the head of each die plane based queue of the host read command queues 480 and fetches the message at the head of each queue in the die plane P0 host read command queue 484 to form commands 491 for scheduling, and fetches the message at the head of each queue in the die plane P1 host read command queue 485 to form commands 492 for scheduling. The CPU then moves on (step 464) to fetch the messages at the head of each of the die plane based low priority read error recovery message queues 479 and fetches the message at the head of each queue in the die plane P0 low priority read error recovery message queues 486 to form commands 493 for scheduling, and fetches the message at the head of each queue in the die plane P1 low priority read error recovery message queue 487 to form commands 494 for scheduling. Finally, the CPU moves on (step 464) to fetch the command at the head of each queue in the low priority command queues 478 to form commands 495 for scheduling. The commands and messages from the heads of the various queues including the plurality of die plane based high priority read error recovery message queues 481 including the die plane P0 high priority read error recovery message queues 482 and die plane P1 high priority read error recovery message queues 483, the plurality of die plane based host read command queues 480 including the die plane P0 host read command queue 484 and the die plane P1 host read command queue 485, plurality of die plane based low priority read error recovery message queues 479 including the die plane P0 low priority read error recovery message queues 486 and die plane P1 low priority read error recovery message queues 487, and the plurality of low priority command queues 478 are all processed, and commands are formed and scheduled for transmission to the flash interface controller to execute the commands or take various actions (step 496).

Transmitting read error recovery messages to die plane queues for scheduling improves the flexibility and efficiency of scheduling messages on AIPR-enabled SSDs. The separation of the high and low priority die based queues as depicted in FIG. 4A into the die plane based queues of FIG. 4B improves efficiency of error recovery and prevents starvation of read error recovery messages on a particular plane. The utilization of die plane based read error recovery message IPC queues utilize AIPR functionality by allowing messages to be scheduled to the even and odd planes of an SSD within the same scheduling iteration to optimize throughput of error recovery messages and improve the speed of performing error recovery on the SSD.

Similarly, by transmitting read commands to a die plane queue for scheduling, the CPU reduces random read command latency, provides a maximum throughput for AIPR-enabled SSDs, and prevents starvation of die plane access commands to improve performance. As described above, the figures illustrate the use of die plane queues in the scheduling of read commands and read error recovery messages, but die plane queues can also be used in IPC queues for other types of commands and messages, for similar improvements to efficiency.

In some implementations, the efficiency of scheduling and executing read commands or other commands can be further improved by also considering and taking into account the priority of the command or message by implementing for each die plane queue two or more priority queues. For example, a high-priority die plane message queue and a low-priority die plane message queue. Other priority levels may also be implemented, while maintaining the die plane queues within each priority level for efficient scheduling to the dies.

By including die plane message queues and high and low priority levels of these per-die plane queues, even higher efficiency in scheduling can be achieved. In some implementations, the CPU can determine which priority queue each message should be assigned based on the type of command. The CPU fetches messages from each of the high and low priority queues for each of the die plane queues, so that the high priority messages need not wait in a queue behind a number of low priority messages. The messages can be processed and sent to the flash interface controller for transmission to the die planes of the NAND device in parallel to improve performance of the device.

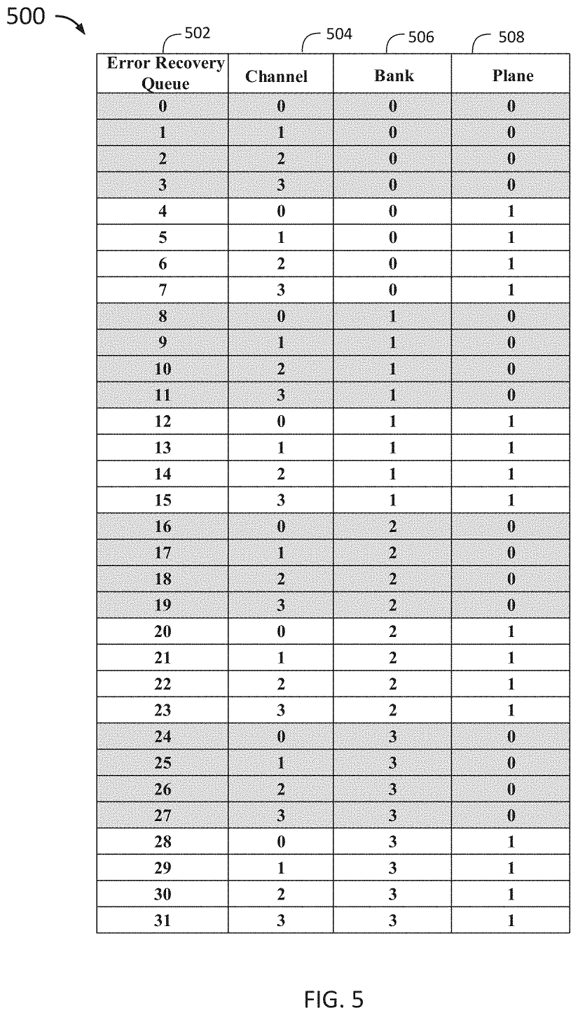

FIG. 5 shows a block diagram of a mapping of read error recovery messages to a die- and plane-based queue for a 4-channel by 4-bank configuration of an AIPR-enabled SSD. In FIG. 5, the error recovery messages are defined on a per plane basis. As described in FIGS. 3B and 4B, the error recovery messages IPC queue includes a queue for each plane in each bank of the device, such that there is a queue corresponding to each bank accessed by a channel. FIG. 5 illustrates a mapping 500 of the channels 504, banks 506, and planes 508 to a die plane error recovery message queue 502 for a 4-channel by 4-bank configuration. If the CPU controls four channels to a NAND package and each channel has four logically independent dies, there are 16 dies or logical unit numbers (“LUNs”) in total. The first plane (P0) and second plane (P1) of each die can operate independently in AIPR mode, so in order to efficiently schedule commands to the die planes, there are 32 planes in total, or 2×16. Using such a mapping, the CPU can send messages specific to each plane in their corresponding queues. For an AIPR-enabled SSD capable of independently accessing both planes of each die in parallel, the mapping of the die planes to a queue improves efficiency of scheduling commands and messages of many types to the SSD, including error recovery messages, host read commands and other command types.

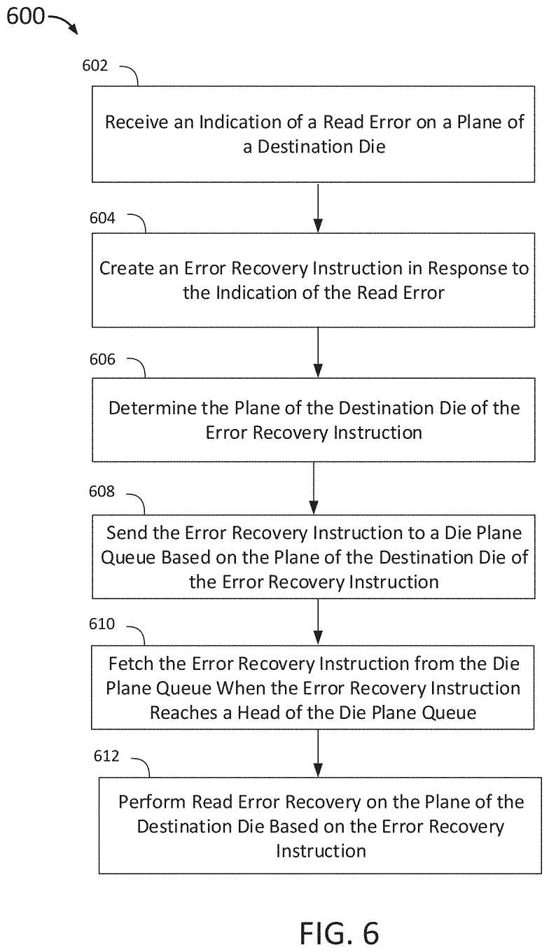

FIG. 6 shows a flow chart of a method 600 for scheduling error recovery instructions (also referred to as error recovery messages herein) with die plane read error recovery queues. The scheduling of the read error recovery instructions is handled at the flash interface CPU (for example flash interface CPU 119 in FIG. 1 or flash interface CPU 219 in FIG. 2). At step 602, the flash interface CPU receives an indication of a read error on a destination die amongst the memory dies coupled to the flash interface CPU within the memory device. The indication is received in response to an attempted read on a destination die, which failed due to an error. At step 604, the flash interface CPU creates an error recovery instruction in response to the indication of the read error. The error recovery instruction indicates that an error has occurred, and may also indicate the destination die on which the error occurred and information about what happened in an error on a memory die and how the error can be recovered. In some implementations, the error recovery instruction also includes indications as to the type or severity of the error that occurred.

At step 606, the flash interface CPU determines the plane of the destination die of the error recovery instruction. In some implementations, the plane of the destination die of the error recovery instruction is the same as the plane of the destination die of the failed read command. In some implementations, more than one destination die or destination plane may be specified by the error recovery instruction. In some implementations, the CPU accesses an internal memory or look up table to determine the plane of the destination die within the connected memory devices. The specifications for the error recovery required by the error recovery instruction may depend on the error recovery algorithm utilized by the SSD and the type or location of the error. In some implementations, the flash interface CPU may also make other determinations based on the error recovery instruction, for example, the flash interface CPU may determine a priority of the error recovery instructions. The flash interface CPU may use these additional determinations to determine a priority queue to which the error recovery instruction will be sent. At step 608, the CPU sends the error recovery instruction to a die plane queue based on the plane of the destination die of the error recovery instruction. The error recovery instruction IPC queues at the flash interface CPU include at least one queue per die plane of the memory device, and the flash interface CPU sends the error recovery instruction to the die plane queue for the plane of the destination die. In some implementations, the read error recovery instruction IPC queues include two or more queues for each die plane of the memory device, each queue associated with a different level of priority or a different scheduling mechanism. The error recovery instruction is sent to the tail of the die plane queue, and moves up through the queue as other messages are fetched from the head of the queue to form commands for scheduling by the flash interface CPU, and are subsequently removed from the queue.

At step 610, the flash interface CPU fetches the error recovery instruction from the die plane queue when the error recovery instruction reaches a head of the die plane queue. The error recovery instruction is then removed from the die plane queue, and a command is formed and scheduled by the flash interface CPU. The flash interface CPU selects the message at the head of each queue in turn according to a scheduling algorithm which determines the selection of the messages. In some implementations, the scheduling algorithm is a round-robin selection method. At step 612, the flash interface CPU performs a read error recovery on the plane of the destination die based on the error recovery instruction. The flash interface CPU sends commands to implement the read error recovery on the various planes of the die based on the read error recovery instruction.

The read error recovery performed is dependent on the type of recovery strategy utilized by the SSD and required by the type of error. In some implementations, the error recovery instruction fetched from the queue causes one or more read commands to be sent to a plane of the die. The read commands may include different V±voltage thresholds for a soft-read process, to reattempt the read and recover from the read error. In some implementations, the error recovery instruction fetched from the queue causes a redundancy assisted type recovery from two or more dies, by causing a first read command to be transmitted to a first destination die over a first channel and a second read command to be transmitted to a second destination die over a second channel. In some implementations this is achieved by encoding data in the dies using a Quadruple Swing-By Code (QSBC) error correction code. In some implementations this is achieved by encoding data in the dies using other data redundancy codes, including, but not limited to, RAID codes and erasure codes. Each of the error recovery strategies may be used in combination with one or more of the aforementioned embodiments. In some implementations, the read error recovery instruction fetched from the queue causes one or more read commands to be sent to planes of the die. The flash interface CPU can transmit in parallel read commands fetched from the even plane queue and the odd plane queue for a destination die.

In some implementations, the flash interface CPU receives an instruction other than the read error recovery instruction and places the received instruction, such as a read command in an IPC queue associated with the destination die and destination plane for the read. Utilizing the die plane queues for commands and messages such as read error recovery instruction and read commands improves the overall efficiency of the device, as instructions from the die plane error recovery instruction queues can be processed in parallel, and commands for error recovery transmitted to the planes of the die to perform error recovery on the two planes in parallel.

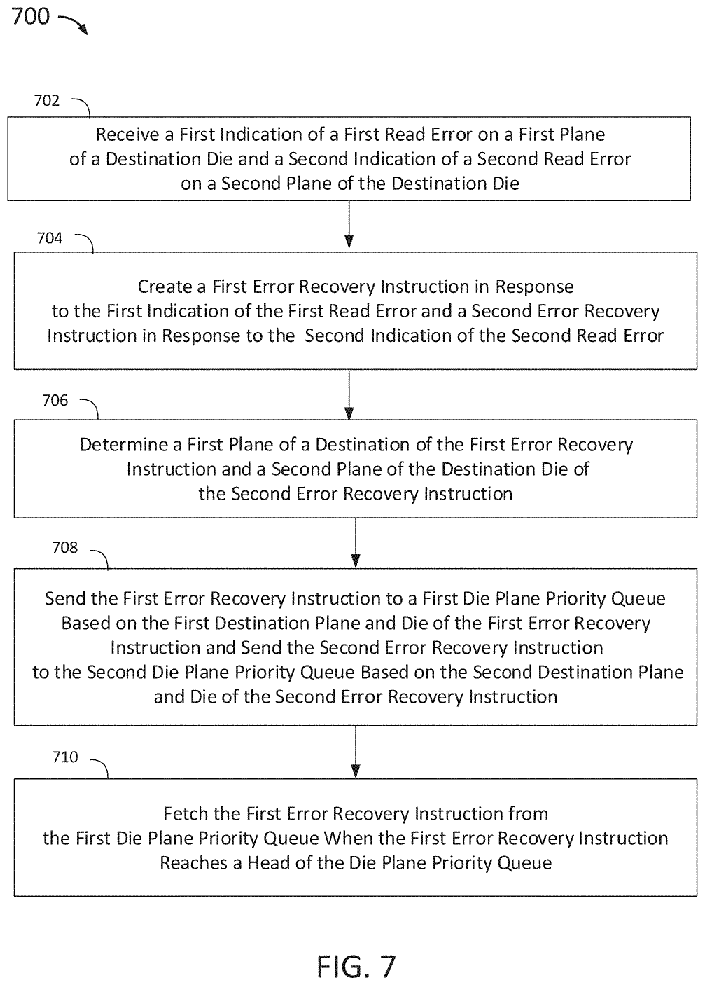

FIG. 7 shows a flow chart of a method 700 for scheduling read error recovery instructions to multiple planes of a die. As described above in FIG. 6, the scheduling of the read error recovery instructions is handled at the flash interface CPU (for example flash interface CPU 119 in FIG. 1 or flash interface CPU 219 in FIG. 2). At step 702, the flash interface CPU receives a first indication of a first read error on a first plane of a destination die and a second indication of a second read error on a second plane of the destination die. Each of the first and second indications is received in response to an attempted read on a destination die, which failed due to an error.

At step 704, the flash interface CPU creates a first error recovery instruction in response to the first indication of the first read error and a second error recovery instruction in response to the second indication of the second read error. The error recovery instruction indicates that an error has occurred, and may also indicate the destination die plane on which the error occurred and information about what happened in an error on a memory die and how the error can be recovered. In some implementations, the error recovery instruction also includes indications as to the type or severity of the error that occurred.

At step 706, the flash interface CPU determines a first plane of a destination die for the first error recovery instruction and a second plane of the destination die for the second error recovery instruction. In some implementations, the plane of the destination die of the error recovery instruction is the same as the plane of the destination die of the failed read command. In some implementations, more than one destination die or destination plane may be specified by the error recovery instruction. In some implementations, the CPU accesses an internal memory or look up table to determine the plane of the destination die within the connected memory devices. The specifications for the error recovery required by the error recovery instruction may depend on the error recovery algorithm utilized by the SSD and the type or location of the error. In some implementations, the flash interface CPU may also make other determinations based on the error recovery instruction, for example, the flash interface CPU may determine a priority of the error recovery instructions. The flash interface CPU may use these additional determinations to determine a priority queue to which the error recovery instruction will be sent.

At step 708, the flash interface CPU sends the first error recovery instruction to a first die plane priority queue based on the first destination plane and die of the first error recovery instruction, and sends the second error recovery instruction to a second die plane priority queue based on the second destination plane and die of the second error recovery instruction. The first error recovery instruction and the second error recovery instruction may be directed to a first and second plane on the same destination die. The two error recovery instructions may have the same priority level assigned to them.

At step 710, the flash interface CPU fetches the first error recovery instruction from the first die plane priority queue when the first error recovery instruction reaches a head of the first die plane priority queue. The flash interface CPU selects the message at the head of each queue in turn according to a scheduling algorithm which determines the selection of the messages. In some implementations, the scheduling algorithm is a round-robin selection method. The flash interface CPU then forms one or more commands for scheduling based on the first error recovery instruction.

The flash interface CPU also fetches the second error recovery instruction from the second die plane priority queue when the second error recovery instruction reaches a head of the second die plane priority queue. The flash interface CPU forms one or more commands for scheduling based on the second error recovery instruction The flash interface CPU can then schedule and perform error recovery on the first plane of the destination die based on the first error recovery instruction. At any time during the execution of commands for the first plane P0, commands for the second plane P1 could be issued in parallel to the commands for the first plane P0 and second planes of the destination die in parallel, using the AIPR mode of the SSD to independently access the two planes.

Sending the error recovery instructions to a queue specific to the destination die plane of the error recovery instruction improves the efficiency of message scheduling and preforming read recovery on the memory device. The die plane-based error recovery instruction queues prevents starvation of die plane read recovery instructions to a particular die. The die plane-based error recovery instruction queues, and any other die plane-based IPC queues, enable the independent and parallel access of both die planes in an AIPR mode. The utilization of die plane based read error recovery message IPC queues utilize AIPR functionality by allowing messages to be scheduled to the even and odd planes of an SSD within the same scheduling iteration to optimize throughput of error recovery messages and improve the speed of performing error recovery on the SSD. These benefits to performance are also achieved by use of die plane queues for other commands and message types received at the flash interface CPU.

Other objects, advantages and embodiments of the various aspects of the present invention will be apparent to those who are skilled in the field of the invention and are within the scope of the description and the accompanying Figures. For example, but without limitation, structural or functional elements might be rearranged consistent with the present invention. Similarly, principles according to the present invention could be applied to other examples, which, even if not specifically described here in detail, would nevertheless be within the scope of the present invention.

What is claimed is:

1. A method of scheduling read commands by a processor communicatively coupled to a NAND memory device comprising an n×m array of NAND memory dies having n channels, wherein each channel of the n channels is communicatively coupled to m NAND memory dies, and each of the n×m NAND memory dies has a first plane and a second plane, the first plane and the second plane being independently accessible, the method comprising:
receiving a first command to perform a first read on a destination die of the n×m array of NAND memory dies;
determining the destination die and a first destination plane of the first read command; and
sending the first read command to a first die plane queue associated with the destination die and first destination plane.

2. The method of claim 1, further comprising:
receiving a second command to perform a second read on the destination die;
determining the destination die and a second destination plane of the second read command; and
sending the second read command to a die plane queue associated with the destination die and the second destination plane.

3. The method of claim 2, further comprising:
fetching the first read command from the first die plane queue according to a selection method; and
fetching the second read command from the second die plane queue according to the selection method.

4. The method of claim 3, further comprising:
performing the first read of first data on the first destination plane of the destination die based on the first read command; and
performing the second read of second data on the second destination plane of the destination die based on the second read command.

5. The method of claim 4, wherein the first read of the first data on the first destination plane is performed in parallel with the second read of the second data on the second destination plane.

6. The method of claim 5, wherein the first die plane queue corresponds to a first plane of a first die of the m dies and a first channel of the n channels, and the second die plane queue corresponds to the second plane of the first die of the m dies and the first channel of the n channels.

7. The method of claim 6, further comprising:
transmitting the first read command and the second read command to the destination die over the first channel of the n channels to the first die of the m dies.

8. The method of claim 3, further comprising:
determining a priority associated with the first read command; and
sending the first read command to a die plane priority queue with the determined priority.

9. The method of claim 8, wherein each of the n×m die queues for each of the first plane and the second plane comprises p die plane priority queues.

10. The method of claim 3, wherein the selection method comprises a round-robin method.

11. A system for scheduling read commands at a processor, the system comprising:
a NAND memory device comprising an n×m array of NAND memory dies having n channels, wherein each channel of the n channels is communicatively coupled to m NAND memory dies, and each of the n×m NAND memory dies has a first plane and a second plane, the first plane and the second plane being independently accessible; and
a processor communicatively coupled to the NAND memory device; the processor comprising:
logic configured to process read commands requesting data from the NAND memory device; and
a die queue for each of a first plane and a second plane of each NAND memory die of the n×m array;
the processor configured to:
receive a first command to perform a first read on a destination die of the n×m array of NAND memory dies;
determine the destination die and a first destination plane of the first read command; and
send the first read command to a first die plane queue associated with the destination die and first destination plane.

12. The system of claim 11, the processor further configured to:
receive a second command to perform a second read on the destination die;
determine the destination die and a second destination plane of the second read command; and
send the second read command to a die plane queue associated with the destination die and the second destination plane.

13. The system of claim 12, the processor further configured to:
fetch the first read command from the first die plane queue according to a selection method; and
fetch the second read command from the second die plane queue according to the selection method.

14. The system of claim 13, the processor further configured to:
perform the first read of first data on the first destination plane of the destination die based on the first read command; and
perform the second read of second data on the second destination plane of the destination die based on the second read command.

15. The system of claim 14, the processor further configured to:
perform the first read of the first data on the first destination plane in parallel with the second read of the second data on the second destination plane.

16. The system of claim 15, wherein the first die plane queue corresponds to a first plane of a first die of the m dies and a first channel of the n channels, and the second die plane queue corresponds to the second plane of the first die of the m dies and the first channel of the n channels.

17. The system of claim 6, the processor further configured to:
transmit the first read command and the second read command to the destination die over the first channel of the n channels to the first die of the m dies.

18. The system of claim 13, the processor further configured to:
determine a priority associated with the first read command; and
send the first read command to a die plane priority queue with the determined priority.

19. The system of claim 18, wherein each of the n×m die queues for each of the first plane and the second plane comprises p die plane priority queues.

20. The system of claim 13, wherein the selection method comprises a round-robin method.
